(19) United States
(12) Patent Application Publication
(10) Pub. No.: US 2015/0205133 A1
(43) Pub. Date: Jul. 23, 2015

(54) DISPLAY DEVICE

(71) Applicant: KABUSHIKI KAISHA TOSHIBA, Tokyo (JP)

(72) Inventors: Takashi SASAKI, Yokohama (JP); Haruhiko OKUMURA, Fujisawa (JP); Aira HOTTA, Kawasaki (JP); Akihisa MORIYA, Kawasaki (JP); Tomoya TSURUYAMA, Kawasaki (JP)

(73) Assignee: KABUSHIKI KAISHA TOSHIBA

(21) Appl. No.: 14/598,317

(22) Filed: Jan. 16, 2015

(30) Foreign Application Priority Data
Jan. 20, 2014 (JP) 2014-007991

(51) Int. Cl. G02B 27/01; G02B 27/00; G09G 5/10; G02B 19/00

(52) U.S. Cl. CPC G02B 27/0172; G02B 19/0047; G02B 27/0093; G09G 5/10; G09G 2354/00; G09G 2320/0626

(57) ABSTRACT

According to one embodiment, a display device includes an image displayer that emits light including image information, a projector, a light condenser that projects the light, and a light controller. The light condenser is provided between the image displayer and the projector in an optical path of the light, and condenses the light. The light controller is provided between the light condenser and the projector in the optical path, and has a first surface. The light controller implements a first operation causing a first portion of the condensed light incident on a first region of the first surface to travel toward the projector and a second operation causing a second portion of the condensed light incident on a second region of the first surface to travel toward the projector. The first region has a configuration or a surface area different from the second region.

### CROSS-REFERENCE TO RELATED APPLICATIONS

This application is based upon and claims the benefit of priority from Japanese Patent Application No. 2014-007991, filed on Jan. 20, 2014; the entire contents of which are incorporated herein by reference.

### FIELD

Embodiments described herein relate generally to a display device.

### BACKGROUND

For example, there is a display device that directly projects an image onto the retina using a Maxwellian view. For example, a pinhole optical system having a pinhole provided in the optical path is used in such a display device. For such an optical system, the region (the viewing zone) where the image is viewed is extremely narrow. A display device by which the viewer can easily view the image is desirable.

### BRIEF DESCRIPTION OF THE DRAWINGS

FIG. 1 is a schematic view illustrating a display device according to a first embodiment;

FIG. 2 is a schematic view illustrating a display device;

FIG. 3 is a schematic view illustrating a display device according to the first embodiment;

FIG. 4A to FIG. 4F are schematic views illustrating operations of the display device according to the first embodiment;

FIG. 5 is a schematic view illustrating a display device according to the first embodiment;

FIG. 6A and FIG. 6B are schematic views illustrating display devices according to the first embodiment;

FIG. 7 is a schematic view illustrating a display device according to the first embodiment;

FIG. 8 is a schematic perspective view illustrating a display device according to the first embodiment;

FIG. 9A to FIG. 9D are schematic views illustrating operations of the display device according to the first embodiment;

FIG. 10A to FIG. 10D are schematic views illustrating operations of the display device according to the first embodiment;

FIG. 11A to FIG. 11D are schematic views illustrating operations of the display device according to the first embodiment;

FIG. 12A to FIG. 12D are schematic views illustrating operations of the display device according to the first embodiment; and

FIG. 13 is a block diagram illustrating a display device according to a second embodiment.

### DETAILED DESCRIPTION

According to one embodiment, a display device includes an image displayer, a projector, a light condenser and a light controller. The image displayer emits light including image information. The projector projects the light. The light condenser is provided between the image displayer and the projector in an optical path of the light. The light condenser condenses the light. The light controller is provided between the light condenser and the projector in the optical path. The light controller has a first surface. The light controller implements a first operation and a second operation. The first operation causes a first portion of the condensed light incident on a first region of the first surface to travel toward the projector. The second operation causes a second portion of the condensed light incident on a second region of the first surface to travel toward the projector. The first region has a configuration different from a configuration of the second region or the first region has a surface area different from a surface area of the second region.

Various embodiments will now be described hereinafter with reference to the accompanying drawings.

The drawings are schematic or conceptual; and the relationships between the thicknesses and widths of portions, the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

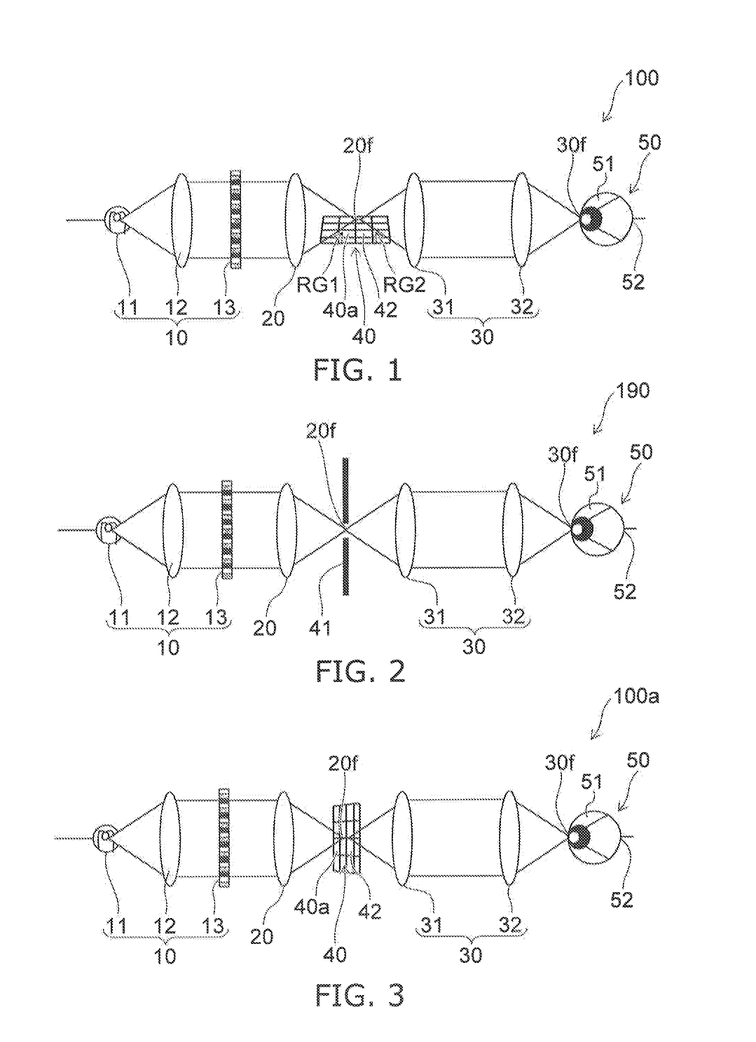

FIG. 1 is a schematic view illustrating a display device according to a first embodiment.

The display device 100 according to the embodiment is a display device that displays an image using a Maxwellian view.

As shown in FIG. 1, the display device 100 includes an image displayer 10, a light condenser 20, a projector 30, and a light controller 40.

In the example, the image displayer 10 includes a light source 11, a light source condensing lens 12, and an LCD panel 13. At least a portion of the light emitted from the light source 11 is incident on the light source condensing lens 12. At least a portion of the light that is incident on the light source condensing lens 12 is incident on the LCD panel 13. The light passes through the LCD panel 13. Thereby, light including image information is produced. The image displayer 10 emits the light including the image information.

The light condenser 20 is provided between the image displayer 10 and the projector 30 in the optical path of the light including the image information. The light controller 40 is provided between the light condenser 20 and the projector 30 in the optical path of the light including the image information.

The light including the image information that is produced is incident on the light condenser 20. The light condenser 20 condenses the light including the image information. The light condenser 20 includes, for example, a convex lens. For example, the light condenser 20 condenses the light that is incident on the light condenser 20 toward a focal point 20f (the light condensing point) of the convex lens.

The light that is condensed toward the focal point 20f is incident on the light controller 40. The light controller 40 has, for example, a first surface 40a. The light controller 40 causes a portion of the light incident on the first surface 40a to travel toward the projector 30. For example, the light controller 40 selectively reflects or transmits the light that is incident on the light controller 40. For example, the light controller 40 reflects a portion of the light that is incident on the light controller 40.

The light controller 40 includes, for example, multiple optical elements 42. Each of the multiple optical elements 42 is provided, for example, in the first surface 40a. The multiple optical elements 42 are arranged in a surface parallel to the first surface 40a. In other words, the multiple optical elements 42 are disposed in an array configuration in the surface parallel to the first surface 40a. For example, a portion of the light condensed by the light condenser 20 is incident on each of the multiple optical elements 42.

For example, an optical switch is provided at each of the multiple optical elements 42. For example, in the state in which the optical switch is ON, each of the multiple optical elements 42 implements a first element operation of causing the light incident on each of the multiple optical elements 42 to travel toward the projector 30. For example, when the optical switch is in the OFF state, each of the multiple optical elements implements a second element operation of not causing the light that is incident on each of the multiple optical elements to travel toward the projector.

The optical element 42 is, for example, a mirror. The light controller 40 is, for example, a multimirror array. By switching the optical switch ON, the optical element 42 reflects the incident light toward the projector 30. By switching the optical switch OFF, the optical element 42 does not reflect the incident light toward the projector 30.

The light controller 40 is used as, for example, an aperture stop. The light controller 40 adjusts the aperture stop (the opening state) of the light. The state (ON or OFF) of the optical switch is switched at each of the multiple optical elements. Thereby, the size, number, position, etc., of the aperture stop may be adjusted. The light controller 40 includes, for example, a matrix addressor using DMDs (Digital Mirror Devices), etc.

At least a portion of the light that is incident on the light controller 40 is incident on the projector 30. The projector 30 condenses the light toward an optical conjugate point 30f of the focal point 20f. Thereby, the projector 30 projects the image. In the example, a first projection lens 31 and a second projection lens 32 are provided in the projector 30. The first projection lens 31 is provided between the second projection lens 32 and the light controller 40 in the optical path of the light. The light that is incident on the projector 30 is condensed toward the optical conjugate point 30f by passing through the first projection lens 31 and the second projection lens 32.

For example, the position of the optical conjugate point 30f is set according to the position of the cornea of an eyeball 51 of a viewer 50 (the user of the display device 100). For example, the projector 30 condenses at least a portion of the light condensed by the light condenser 20 toward the eye (the eyeball 51) of the viewer 50 of the image. Thereby, the light that is condensed toward the optical conjugate point 30f is incident on the eye (the eyeball 51) of the viewer 50. The projector 30 projects the image onto a retina 52 of the viewer 50. An image is imaged on the retina 52 of the viewer 50 by the light that is incident on the eyeball 51. Thereby, the viewer 50 perceives the image generated by the image displayer 10.

FIG. 2 is a schematic view illustrating a display device.

FIG. 2 shows the display device 190 of a reference example. The image displayer 10, the light condenser 20, and the projector 30 are provided in the display device 190 as well. Configurations similar to the configurations described in regard to the display device 100 are applicable to these components.

A light controller 41 is provided in the display device 190. In the example, a pinhole is used as the light controller 41. The light controller 41 is provided between the projector 30 and the light condenser 20 in the optical path of the light including the image information. The pinhole is disposed at a position corresponding to the focal point 20f.

For example, a Maxwellian view is used in the display device 100 and the display device 190. Thereby, image information can be provided to the retina without being dependent on, for example, the properties of the eyeball optical system or the eyeball adjustment state of the human. In other words, for example, it is possible to form the image on the retina even in the state in which an extremely close-range view is viewed such as when reading a book, and even in the state in which an extremely distant view is viewed such as general viewing of a landscape.

An image presentation method is being pioneered in which the actual world and image information are perceived harmoniously by providing the image information and the external environment information to the viewer by superimposing the image information and the external environment information in the state of being able to optically see through (AR (Augmented Reality)).

In the AR display, the image information that is superimposed with the external environment information is provided using a Maxwellian view. Thereby, for example, the image information can be provided clearly without being dependent on the eyeball adjustment state of the viewer. In other words, the image information and the external environment information can be superimposed without changing the state of the image that is provided and regardless of the spatial position focused on by the viewer.

A Fourier-transformed image of the light including the image information condensed using the small opening is provided to the cornea of the viewer. Thereby, the Maxwellian view can be used. For example, the light that includes the image information is once condensed; and the conjugate state of the condensed state is created on the cornea. Therefore, the width of the opening is extremely narrow; and there are cases where there are pronounced differences according to the visual function of the viewer. For example, the width of the opening may differ greatly and is about 1 mm to about 0.1 mm.

In the case where the image is viewed by the Maxwellian view as shown in FIG. 2, the aperture stop diameter (e.g., the diameter of the pinhole) of the light condenser 20 is small. Therefore, there are cases where the region where the viewer 50 can perceive the image, that is, the position (the viewing zone) of the viewpoint where the image information is receivable, is markedly limited. In other words, in the case where the display device 190 is used, although the image can be viewed at some viewpoint, the image is easily lost sight of due to eyeball movement or shifting of the head position.

For example, there is a display device of another reference example in which the opening for the light is multiply provided. The viewing zone can be widened by providing the multiple openings. However, shifting that is dependent on the number of openings occurs for the many images. Thereby, the image that is imaged on the retina degrades markedly.

Conversely, in the display device 100 according to the embodiment, the position of the light that the light controller 40 reflects (or transmits), etc., can be adjusted according to the position of the eye (the eyeball 51) of the viewer 50. For example, the opening state (e.g., the position of the reflected light, etc.) is changed dynamically according to the position of the eye. Thereby, the image can be perceived even when the eyeball moves. A wide viewing zone is provided by the display device using the Maxwellian view. In the display device 100, the image is easy to view even when the eyeball position, the eyeball rotation state, and the position of the head change. Also, the opening state can be adjusted to match the visual function of the viewer. An easily-viewable display can be provided.

FIG. 3 is a schematic view illustrating a display device according to the first embodiment.

As shown in FIG. 3, the display device 100a includes the image displayer 10, the light condenser 20, the projector 30, and the light controller 40.

The configurations described in regard to the display device 100 are applicable to the image displayer 10, the light condenser 20, and the projector 30. In the example, for example, the light controller 40 transmits a portion of the light that is incident on the light controller 40.

The light controller 40 includes multiple optical elements 42. In the example, the optical element 42 transmits the light that is incident on the optical element 42 toward the projector 30 in the state in which the optical switch is ON. When the optical switch is in the OFF state, the light that is incident on the optical element 42 is not transmitted toward the projector 30.

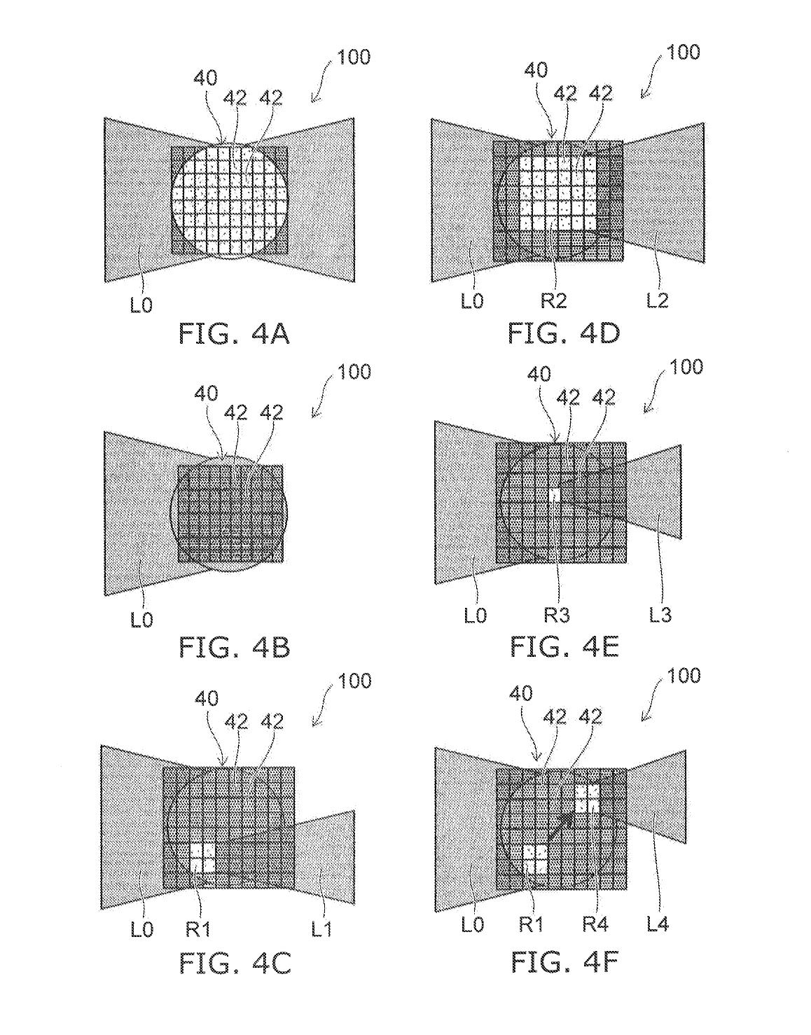

FIG. 4A to FIG. 4F are schematic views illustrating operations of the display device according to the first embodiment.

FIG. 4A to FIG. 4F show operations of the light controller 40.

Light L0 that is condensed by the light condenser 20 is incident on the light controller 40. For example, a portion of the light L0 is reflected or transmitted by each of the optical elements 42. In the following example, the case is described where the light that is incident in the state in which the optical element 42 is ON is reflected toward the projector 30. As described above, the optical element 42 may be an element that transmits the light that is incident toward the projector 30 in the ON state.

In FIG. 4A, each of the multiple optical elements 42 of the light controller 40 is in, for example, the ON state. At this time, for example, the light L0 that is incident on the light controller 40 is reflected by all of the optical elements 42 and travels toward the projector 30.

In FIG. 4B, each of the multiple optical elements 42 is in the OFF state. At this time, for example, the light L0 that is incident on the light controller 40 is not reflected toward the projector 30. However, there are cases where off-axis light is emitted from the mirror array in directions different from the direction toward the projector 30. Such light is not effective for, for example, the display function of the display device.

FIG. 4C shows the state in which the optical elements 42 provided in a first element region R1 of the light controller 40 are ON. The optical elements 42 provided in regions other than the first element region R1 are in the OFF state. In such a case, light L1 of the light L0 that is incident on the first element region R1 is reflected toward the projector 30.

The light controller 40 is provided at a position corresponding to, for example, the light condensing point of the light L0. The light controller 40 is disposed substantially at the light condensing point of the light L0. The aperture stop of the light controller 40 can be adjusted using the size of the reflective surface, the configuration of the reflective surface, etc. In other words, the reflected light in the state of FIG. 4C corresponds to luminous flux passing through an aperture stop that is smaller than that of the reflected light in the state of FIG. 4A.

FIG. 4D shows the state in which the optical elements 42 provided in a second element region R2 of the light controller 40 are ON. The optical elements 42 provided in regions other than the second element region R2 are in the OFF state. For example, the surface area of the second element region R2 is greater than the surface area of the first element region R1. In such a case, light L2 of the light L0 that is incident on the second element region R2 is reflected toward the projector 30.

For example, the number of the optical elements 42 for which the optical switch is ON in the state of FIG. 4D is greater than the number of the optical elements 42 for which the optical switch is ON in the state of FIG. 4C. The state of FIG. 4D corresponds to a state in which the diameter of the aperture stop is larger than that of the state of FIG. 4C.

FIG. 4E shows the state in which the optical element 42 provided in a third element region R3 of the light controller 40 is ON. The optical elements 42 provided in regions other than the third element region R3 are in the OFF state. For example, the surface area of the third element region R3 is less than the surface area of the first element region R1. In such a case, light L3 of the light L0 that is incident on the third element region R3 is reflected toward the projector 30.

For example, the number of the optical elements 42 for which the optical switch is ON in the state of FIG. 4E is less than the number of the optical elements 42 for which the optical switch is ON in the state of FIG. 4C. The state of FIG. 4E corresponds to a state in which the diameter of the aperture stop is smaller than that of the state of FIG. 4C.

The conjugate image that is projected onto the cornea has a shape that reflects the aperture stop diameter. For example, the conjugate image that is projected in the state of FIG. 4D is larger than the conjugate image that is projected in the state of FIG. 4C. For example, the conjugate image that is projected in the state of FIG. 4E is smaller than the conjugate image that is projected in the state of FIG. 4C.

As shown in FIG. 4F, it is possible to change from the state in which the optical elements 42 provided in the first element region R1 are ON to the state in which the optical elements 42 provided in a fourth element region R4 are ON. In such a case, the state in which the light L1 of the light L0 is incident on the first element region R1 and reflected toward the projector 30 is changed to the state in which light L4 of the light L0 is incident on the fourth element region R4 and reflected toward the projector 30. This corresponds to dynamically moving the position of the aperture stop. Corresponding to this change, the position of the conjugate image of the focal point image on the cornea also changes. In the light controller 40, the position of the viewpoint can be controlled by controlling the optical elements 42.

In other words, the light controller 40 is capable of implementing the first operation of causing a first portion of the light L0 incident on a first region RG1 of the first surface 40a to travel toward the projector 30. Further, the light controller 40 is capable of implementing the second operation of causing a second portion of the light L0 incident on a second region RG2 of the first surface 40a to travel toward the projector 30.

For example, in the first operation, the first portion is reflected at the first region RG1 and travels toward the projector 30. Or, in the first operation, the first portion passes through the first region RG1 and travels toward the projector 30. The projector condenses at least a portion of the first portion toward the optical conjugate point of the light condensing point. Thereby, the image can be displayed.

The first region RG1 and the second region RG2 are modifiable by controlling the state (ON or OFF) of each of the multiple optical elements 42. For example, at least one of the first to fourth element regions R1 to R4 may be used as the first region RG1. A region of the first to fourth element regions R1 to R4 other than the first region RG1 may be used as the second region RG2.

At least one of the configuration or surface area of the first region RG1 is different from that of the second region RG2. In other words, the first region RG1 has at least one of a configuration that is different from the configuration of the second region RG2 or a surface area that is different from the surface area of the second region RG2. For example, the surface area of the first region RG1 and the surface area of the second region RG2 are different from each other. For example, the configuration of the first region RG1 and the configuration of the second region RG2 are different from each other. For example, the density of the luminous flux of the first portion of the light L0 is different from the density of the luminous flux of the second portion of the light L0.

Thus, the light controller 40 is controlled according to the position of the eye (the eyeball 51) of the viewer, etc. Thereby, the viewing zone substantially can be widened. According to the embodiment, an easily-viewable display device using a Maxwellian view is provided.

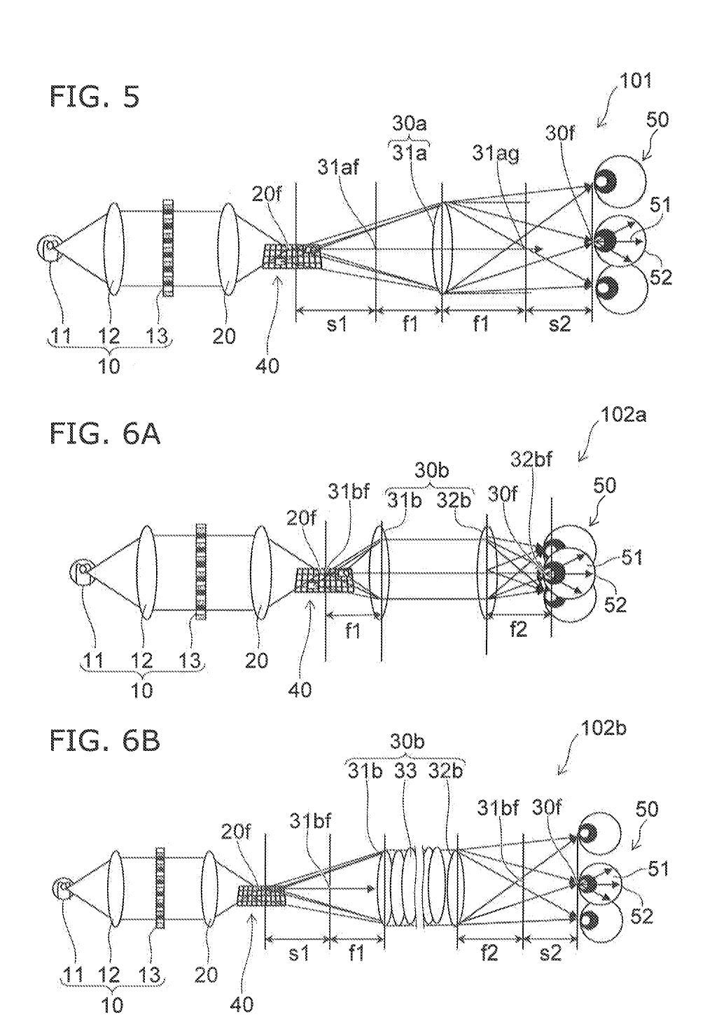

FIG. 5 is a schematic view illustrating a display device according to the first embodiment.

As shown in FIG. 5, the image displayer 10, the light condenser 20, and the light controller 40 are provided in the display device 101 as well. The configurations described in regard to the display device 100 are applicable to these components.

A projector 30a is provided in the display device 101. A first projection lens 31a is provided in the projector 30a. At least a portion of the light that is incident on the light controller 40 is incident on the projector 30a.

For example, the first projection lens 31a has a first focal point 31af and a second focal point 31ag. For example, the first focal point 31af is disposed on the light controller 40 side of the first projection lens 31a in the optical path of the light. The second focal point 31ag is disposed in the optical path of the light on the side of the first projection lens 31a opposite to the light controller 40.

The focal length of the first projection lens 31a is a first focal length f1. In the display device 101, the distance between the first focal point 31af and the focal point 20f is a first distance S1. The distance between the second focal point 31ag and the optical conjugate point 30f is a second distance S2. S1×S2 is a constant. By using such a disposition, the change of the position of the optical conjugate point 30f can be increased or reduced. In other words, the substantial viewing zone can be enlarged or reduced by selecting the projection lens. For example, the layout of the viewing position can be set freely.

FIG. 6A and FIG. 6B are schematic views illustrating display devices according to the first embodiment.

As shown in FIG. 6A and FIG. 6B, the image displayer 10, the light condenser 20, and the light controller 40 are provided in the display devices 102a and 102b as well. The configurations described in regard to the display device 100 are applicable to these components.

A projector 30b is provided in the display devices 102a and 102b. A first projection lens 31b and a second projection lens 32b are provided in the projector 30b. At least a portion of the light that is incident on the light controller 40 is incident on the projector 30b. The first projection lens 31b is provided between the second projection lens 32b and the light controller 40 in the optical path of the light including the image information.

In the display device 102b as shown in FIG. 6B, for example, one or more third projection lenses 33 may be provided between the first projection lens 31b and the second projection lens 32b.

The first projection lens 31b has a first focal point 31bf. The second projection lens 32b has a second focal point 32bf. For example, the first focal point 31bf is disposed in the optical path of the light on the light controller 40 side of the first projection lens 31b. For example, the second focal point 32bf is disposed in the optical path of the light on the side of the second projection lens 32b opposite to the light controller 40.

For example, the focal length of the first projection lens 31b is the first focal length f1. The focal length of the second projection lens 32b is a second focal length f2. In the display device 102b, the distance between the first focal point 31bf and the focal point 20f is the first distance S1. The distance between the second focal point 32bf and the optical conjugate point 30f is the second distance S2. Here, the relationship S1×S2=−f1×f2 holds. Thus, multiple projection lenses are provided in the projector 30. Thereby, the degrees of freedom of the disposition of the light condensing point (the light controller 40 on the object side) and the degrees of freedom of the disposition of the optical conjugate point 30f (the corneal plane on the image side) can be increased.

For example, in the case where the projector 30 has a single-lens configuration, there are cases where the relationship between the position on the object side (the position of the focal point 20f) and the position on the image side (the optical conjugate point 30f) is uniquely determined.

On the other hand, multiple lenses are provided in the projector 30 as in the display devices 102a and 102b. Thereby, the light controller 40, the optical conjugate point 30f, etc., may be disposed by considering the ratio of the first focal length f1 (the combined front-side focal length) and the second focal length f2 (the combined backside focal length). The enlargement ratio of the conjugate image can be changed by changing the second focal length f2. Thereby, the image of the light controller 40 can be enlarged; and the image after changing the opening position of the light controller 40 can be provided to the viewer in a wide region.

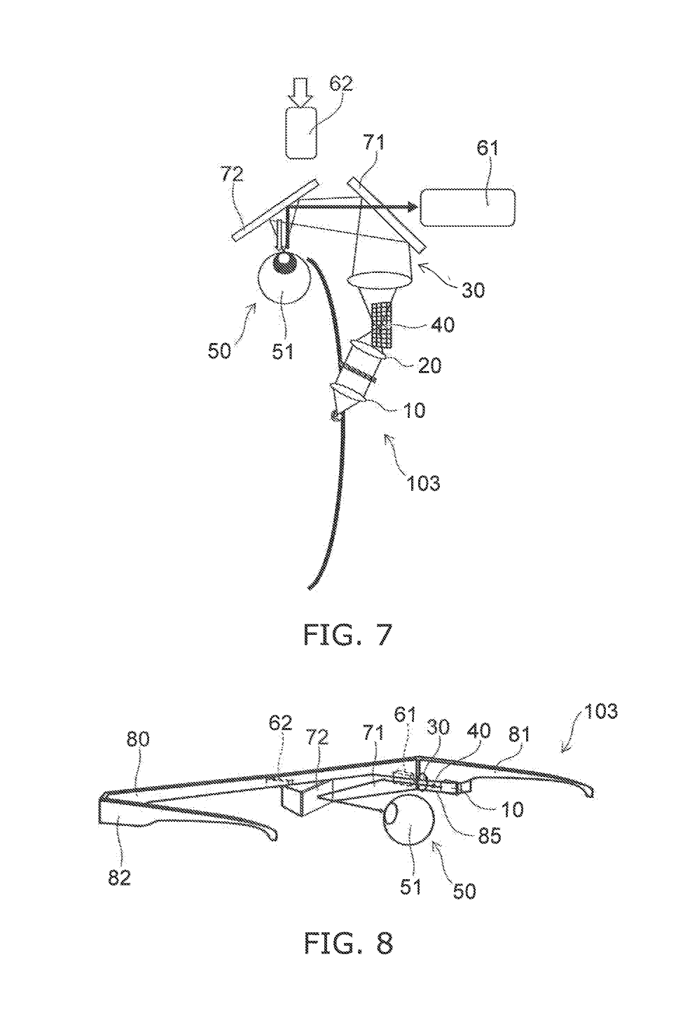

FIG. 7 is a schematic view illustrating a display device according to the first embodiment.

FIG. 7 shows the system configuration of the display device 103. As shown in FIG. 7, the image displayer 10, the light condenser 20, the projector 30, and the light controller 40 are provided in the display device 103 as well. The configurations described in regard to the display device 101 are applicable to these components.

In the display device 103, the projector 30 includes, for example, a half mirror. In the example, a first half mirror 71 and a second half mirror 72 are provided. For example, the first half mirror 71 is provided between the second half mirror 72 and the light controller 40 in the optical path of the light including the image information.

The display device 103 further includes a first sensor 61 and a second sensor 62. The first sensor 61 includes, for example, a camera, etc. The first sensor 61 senses the position of the eye (the eyeball 51) of the viewer 50 of the image.

For example, the eyeball 51, the second half mirror 72, the first half mirror 71, and the first sensor 61 are arranged in this order in the optical path of the light including the positional information of the eyeball 51. The opening of the light controller 40 is changed according to the positional information of the eyeball 51 that is sensed by the first sensor 61. In other words, the light controller 40 switches between the first operation and the second operation according to the position of the eyeball 51 that is sensed. Thereby, an image display suited to the state of the viewer can be performed.

The second sensor 62 includes, for example, a camera, etc. The second sensor 62 senses the external environment, the external light luminance, or the external conditions of the viewer 50 to which the display device 103 is mounted. For example, the second sensor 62 is disposed to match the visual axis of the viewer 50. However, the position at which the second sensor 62 is disposed is not limited to that recited above. For example, the second sensor 62 may be adjacent to the system (the image displayer 10, the light condenser 20, the projector 30, and the light controller 40) or may be distal to the system.

FIG. 8 is a schematic perspective view illustrating a display device according to the first embodiment.

As shown in FIG. 8, the display device 103 may further include a holder 80.

The holder 80 holds at least the projector 30. The holder 80 regulates the spatial arrangement between the projector 30 and the eyeball 51 of the viewer 50. For example, the holder 80 holds the image displayer 10, the light condenser 20, the light controller 40, the projector 30, the first sensor 61, and the second sensor 62. For example, a housing 85 is provided in the holder 80. For example, the image displayer 10, the light condenser 20, the light controller 40, and the projector 30 are contained inside the housing 85.

For example, the holder 80 includes a right-side holding member 81 and a left-side holding member 82. The right-side holding member 81 is designed to contact the right-side portion (e.g., the vicinity of the ear on the right side) of the head of the viewer 50. The left-side holding member 82 is designed to contact the left-side portion (e.g., the vicinity of the ear on the left side) of the head of the viewer 50. Thereby, the holder 80 regulates the spatial arrangement between the image displayer 10, the light condenser 20, the light controller 40, the projector 30, the first sensor 61, the second sensor 62, and the eyeball 51 of the viewer 50. Due to the holder 80, the light is stably incident on the eyeball 51; and a stable display is possible.

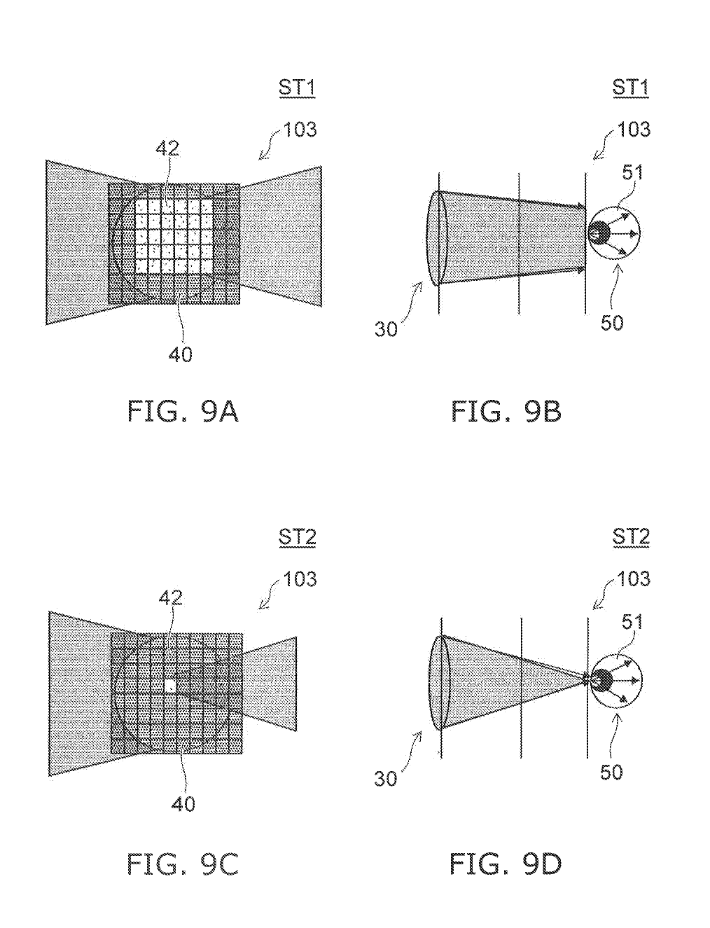

FIG. 9A to FIG. 9D are schematic views illustrating operations of the display device according to the first embodiment.

FIG. 9A showing the operation of the light controller 40 in a first state ST1.

FIG. 9B shows the operation of the projector 30 in the first state ST1.

FIG. 9C shows the operation of the light controller 40 in a second state ST2.

FIG. 9D shows the operation of the projector 30 in the second state ST2.

The first state ST1 is, for example, the state before the display device 103 is mounted or directly after the display device 103 is mounted. The second state ST2 is, for example, the state after the display device 103 is mounted. For example, the second state ST2 is the state after the first state ST1.

In the first state ST1 as shown in FIG. 9A, for example, the opening width of the light controller 40 is set to be wide (the number of the optical elements 42 in the ON state is increased). At this time, the viewing zone of the viewer 50 is wide as shown in FIG. 9B. Thereby, the viewer 50 can easily match the position of the eyeball 51 to the viewing zone.

For example, the first sensor 61 senses the position of the eyeball 51. For example, the display device 103 transitions from the first state ST1 to the second state ST2 based on the position that is sensed.

In the second state ST2 as shown in FIG. 9C, the opening width of the light controller 40 is set to be narrow (the number of the optical elements 42 in the ON state is reduced). Thereby, as shown in FIG. 9D, the conjugate image is disposed at the position of the eyeball 51. Thus, the viewing zone is widened directly after the mounting. Subsequently, the position of the eyeball is sensed; and the image is disposed to match the position that is sensed.

In other words, the light controller 40 implements the first operation before the position of the eyeball 51 is sensed and implements the second operation after the position of the eyeball 51 is sensed. In such a case, the surface area of the first region RG1 is greater than the surface area of the second region RG2. According to this method, the viewer can view the image easily.

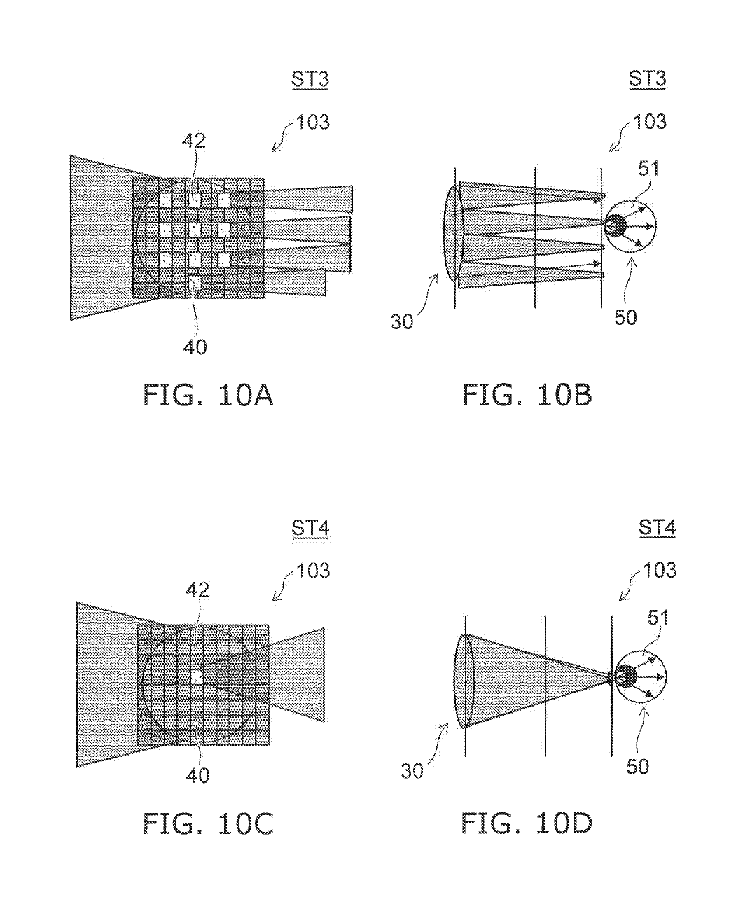

FIG. 10A to FIG. 10D are schematic views illustrating operations of the display device according to the first embodiment.

FIG. 10A shows the operation of the light controller 40 in a third state ST3.

FIG. 10B shows the operation of the projector 30 in the third state ST3.

FIG. 10C shows the operation of the light controller 40 in a fourth state ST4.

FIG. 10D shows the operation of the projector 30 in the fourth state ST4.

The third state ST3 is, for example, the state before the display device 103 is mounted or directly after the display device 103 is mounted. The fourth state ST4 is, for example, the state after the display device 103 is mounted. The fourth state ST4 is, for example, the state after the third state ST3.

As shown in FIG. 10A, for example, the optical element 42 is in the ON state in each of multiple mutually-separated portions of the light controller 40. At this time, as shown in FIG. 10B, multiple portions of luminous flux are incident on the viewer 50. Thereby, the viewer 50 can easily match the position of the eyeball 51 to the viewing zone.

For example, the first sensor 61 senses the position of the eyeball 51. For example, the display device 103 transitions from the third state ST3 to the fourth state ST4 based on the position that is sensed.

In the fourth state ST4 as shown in FIG. 10C, the optical elements 42 other than the optical element 42 corresponding to the sensed position of the eyeball are set to the OFF state. Further, for example, the optical element 42 corresponding to the sensed position of the eyeball is set to the ON state. Thereby, as shown in FIG. 10D, the conjugate image is disposed at the position of the eyeball 51. Thus, the viewing zone is widened directly after the mounting. Subsequently, the position of the eyeball is sensed; and the image is disposed to match the position that is sensed. According to this method, the viewer can view the image easily.

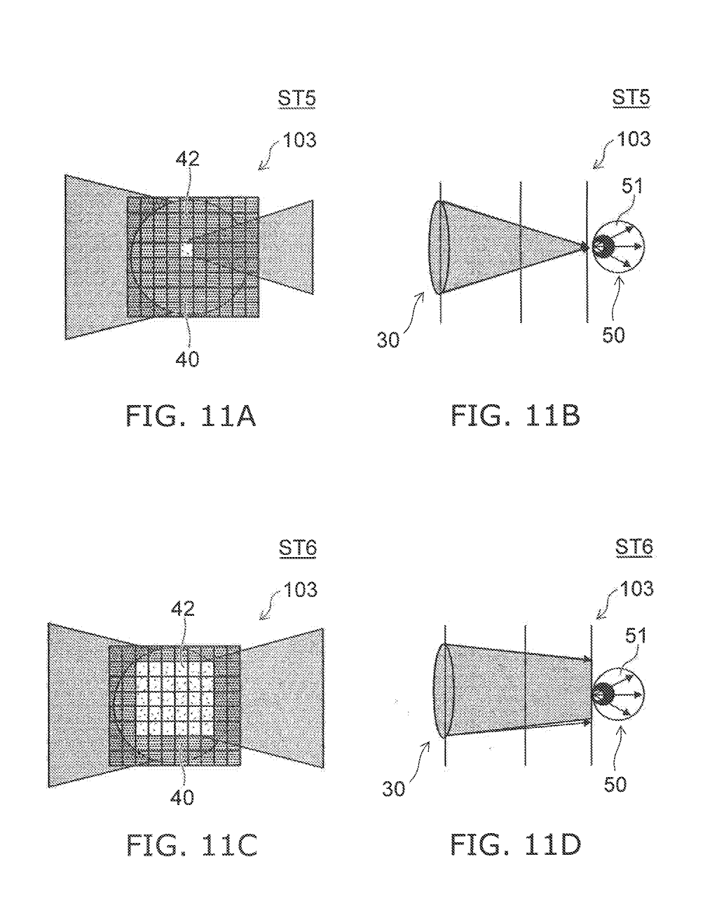

FIG. 11A to FIG. 11D are schematic views illustrating operations of the display device according to the first embodiment.

FIG. 11A shows the operation of the light controller 40 in a fifth state ST5.

FIG. 11B shows the operation of the projector 30 in the fifth state ST5.

FIG. 11C shows the operation of the light controller 40 in a sixth state ST6.

FIG. 11D shows the operation of the projector 30 in the sixth state ST6.

The fifth state ST5 is, for example, the state of the display device in which the external environment is dark. For example, this state is a state in which the viewer is indoors, etc. The sixth state ST6 is, for example, the state of the display device in which the external environment is bright. For example, this state is a state in which the viewer is outdoors, etc.

In the fifth state ST5 as shown in FIG. 11A, the opening width of the light controller 40 is narrow. At this time, as shown in FIG. 11B, the amount of light that is incident on the eyeball 51 of the viewer 50 is low. The display luminance of the image is low.

In the sixth state ST6 as shown in FIG. 11C, the opening width of the light controller 40 is wide. At this time, as shown in FIG. 11D, the amount of the light that is incident on the eyeball 51 of the viewer 50 is high. The display luminance of the image is high.

For example, the diameter of the pupil of the eyeball 51 can be sensed by the first sensor 61. For example, the display device 103 transitions from one state of the fifth state ST5 or the sixth state ST6 to the other state of the fifth state ST5 or the sixth state ST6 when the diameter of the pupil that is sensed changes greatly.

For example, the external light luminance is sensed by the second sensor 62. The display device 103 transitions from one state of the fifth state ST5 or the sixth state ST6 to the other state of the fifth state ST5 or the sixth state ST6 when the external light luminance that is sensed changes greatly.

For example, when the external light luminance becomes bright, the light controller 40 increases the reflecting surface area to match the external light luminance. For example, the display luminance is controlled according to the ratio of the display luminance to the external light luminance. For example, the reflecting surface area is controlled to be proportional to this ratio.

For example, the light controller 40 switches between the first operation and the second operation according to the ratio of the brightness of the surroundings and the brightness of the light emitted from the image displayer 10.

Also, the image displayer 10 changes the brightness of the light emitted from the image displayer according to the ratio of the brightness of the surroundings and the brightness of the light emitted from the image displayer 10.

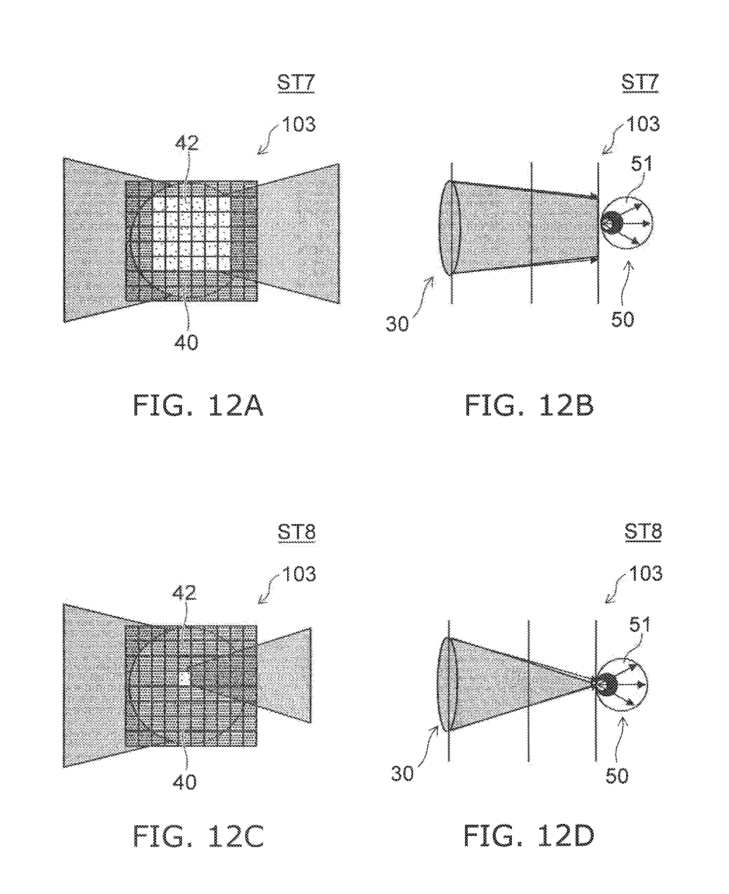

FIG. 12A to FIG. 12D are schematic views illustrating operations of the display device according to the first embodiment.

FIG. 12A shows the operation of the light controller 40 in a seventh state ST7.

FIG. 12B shows the operation of the projector 30 in the seventh state ST7.

FIG. 12C shows the operation of the light controller 40 in an eighth state ST8.

FIG. 12D shows the operation of the projector 30 in the eighth state ST8.

In the example, the display device 103 is used as a head mounted display (HMD) device.

For example, in the seventh state ST7 as shown in FIG. 12A, the opening width of the light controller 40 is set to be wide. At this time, as shown in FIG. 12B, the viewing zone of the viewer 50 is wide. Thereby, the viewer 50 can easily match the position of the eyeball 51 to the viewing zone.

For example, the first sensor 61 senses the position of the eyeball 51. For example, the display device 103 transitions from the seventh state ST7 to the eighth state ST8 based on the position that is sensed.

In the eighth state ST8 as shown in FIG. 12C, the opening width of the light controller 40 is set to be narrow. Thereby, as shown in FIG. 12D, the conjugate image is disposed at the position of the eyeball 51.

For example, in the HMD, the display position is mechanically adjusted to match the viewer. Thereby, the display can be viewed. On the other hand, in the display device of the embodiment, the region where the viewing position can be controlled is wide. Therefore, for example, the viewer can view the display without performing a mechanical adjustment. At the start of the viewing directly after the HMD is mounted, the viewer can easily match the position of the eyeball to the viewing zone by using a wide region of reflected light or multiple portions of luminous flux. After the position of the eyeball is sensed by the first sensor 61, the conjugate image is provided according to the position.

### Second Embodiment

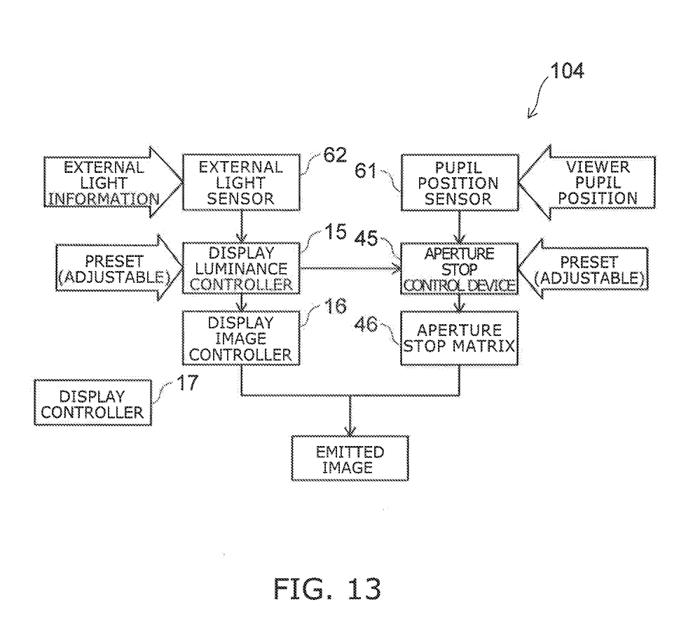

FIG. 13 is a block diagram illustrating a display device according to a second embodiment.

The display device 104 according to the embodiment includes the image displayer 10, the light condenser 20, the projector 30, the light controller 40, the first sensor 61 (the pupil position sensor), and the second sensor 62 (the external light sensor). The configurations described in regard to the display device according to the first embodiment are applicable to these components. The display device 104 further includes an aperture stop control device 45, a display luminance controller 15, a display image controller 16, and a display controller 17.

The pupil position sensor senses the position of the pupil of the viewer. The aperture stop control device 45 controls the aperture stop of the light controller 40 based on the information of the position of the pupil that is sensed. Thereby, for example, an aperture stop matrix 46 is formed. For example, the aperture stop control device 45 can provide the initial state (preset). For example, the initial state is appropriately adjustable.

The external light sensor senses the luminance of the external light of the external environment of the display device, etc. The display luminance controller 15 controls the display luminance of the image displayer 10 based on the external light luminance that is sensed. Also, the display image controller 16 controls the image generated by the image displayer 10 according to the operation of the display luminance controller 15. For example, the aperture stop control device 45 may control the aperture stop of the light controller 40 according to the operation of the display luminance controller 15. For example, the display luminance controller 15 can provide the initial state (preset). For example, the initial state is appropriately adjustable.

The light that is emitted from the image displayer 10 is controlled by the display luminance controller 15, the display image controller 16, and the display controller 17.

The light including the image information that is generated is incident on the light controller 40 controlled by the aperture stop control device 45 and incident on the projector 30. Thereby, the emitted image is formed; and the viewer 50 perceives the image.

According to the embodiment, an easily-viewable display device using a Maxwellian view can be provided.

According to the embodiments, an easily-viewable display device can be provided.

In the specification of the application, “parallel” refer to not only strictly parallel but also include, for example, the fluctuation due to manufacturing processes, etc. It is sufficient to be substantially parallel.

Hereinabove, embodiments of the invention are described with reference to specific examples. However, the embodiments of the invention are not limited to these specific examples. For example, one skilled in the art may similarly practice the invention by appropriately selecting specific configurations of components such as the image displayer, the projector, the light condenser, the light controller, the optical element, the first sensor, the second sensor, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included. Moreover, all display device practicable by an appropriate design modification by one skilled in the art based on the display devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A display device comprising:
an image displayer that emits light including image information;
a projector that projects the light;
a light condenser provided between the image displayer and the projector in an optical path of the light, the light condenser condensing the light; and
a light controller provided between the light condenser and the projector in the optical path, the light controller having a first surface,
wherein
the light controller implements:
a first operation causing a first portion of the condensed light incident on a first region of the first surface to travel toward the projector; and
a second operation causing a second portion of the condensed light incident on a second region of the first surface to travel toward the projector, and
the first region has a configuration different from a configuration of the second region or the first region has a surface area different from a surface area of the second region.

2. The device according to claim 1, wherein
the light condenser condenses the light including the image information toward a light condensing point, and
the light controller is provided at a position corresponding to the light condensing point.

3. The device according to claim 2, wherein the projector condenses at least a portion of the first portion toward an optical conjugate point of the light condensing point.

4. The device according to claim 1, wherein
the light controller includes a plurality of optical elements, and
each of the plurality of optical elements implements:
a first element operation of causing a portion of the condensed light incident on each of the plurality of optical elements to travel toward the projector; and
a second element operation of not causing the portion to travel toward the projector.

5. The device according to claim 4, wherein the plurality of optical elements is arranged in a surface parallel to the first surface.

6. The device according to claim 1, wherein the light controller causes the first portion to travel toward the projector by reflecting at the first region.

7. The device according to claim 1, wherein the light controller causes the first portion to travel toward the projector by transmitting at the first region.

8. The device according to claim 1, wherein a density of luminous flux of the first portion is different from a density of luminous flux of the second portion.

9. The device according to claim 1, wherein
the projector includes a first projection lens and a second projection lens, and
the first projection lens is provided between the second projection lens and the light controller in the optical path.

10. The device according to claim 9, wherein
the projector further includes a third projection lens, and
the third projection lens is provided between the first projection lens and the second projection lens in the optical path.

11. The device according to claim 1, wherein the projector condenses at least a portion of the condensed light toward an eye of a viewer.

12. The device according to claim 1, wherein the projector projects the image toward a retina of a viewer.

13. The device according to claim 1, further comprising a holder that holds at least the projector,
wherein the holder regulates a spatial arrangement between the projector and an eye of a viewer.

14. The device according to claim 1, further comprising a first sensor,
wherein the first sensor senses a position of an eye of a viewer of the image.

15. The device according to claim 14, wherein the light controller implements at least one of the first operation or the second operation according to the position of the eye sensed by the first sensor.

16. The device according to claim 14, wherein
the surface area of the first region is greater than the surface area of the second region, and
the light controller implements the first operation before the sensing of the eye by the first sensor and implements the second operation after the sensing.

17. The device according to claim 1, further comprising a second sensor,
wherein the second sensor senses a brightness of the surroundings of the second sensor.

18. The device according to claim 17, wherein the image displayer changes an intensity of the light emitted from the image displayer according to a ratio of a brightness of the light emitted from the image displayer to the brightness of the surroundings.

19. The device according to claim 17, wherein the light controller implements at least one of the first operation or the second operation according to a ratio of a brightness of the light emitted from the image displayer to the brightness of the surroundings.
